(19) United States
(12) Patent Application Publication
(10) Pub. No.: US 2022/0290470 A1
(43) Pub. Date: Sep. 15, 2022

(54) INTERIOR OPENING CONTROL

(71) Applicant: AKWEL VIGO SPAIN SL, Vigo Pontevedra (ES)

(72) Inventors: Delmiro Javier COUTO MAQUIEIRA, Pontevedra (ES); José Oscar VAZQUEZ CARBALLO, Vigo (ES); Julio GARCIA RODRIGUEZ, Pontevedra (ES); Oscar PAMPIN AGRA, Vigo Pontevedra (ES)

(73) Assignee: AKWEL VIGO SPAIN SL, Vigo Pontevedra (ES)

(21) Appl. No.: 17/692,837

(22) Filed: Apr. 20, 2022

(30) Foreign Application Priority Data
Mar. 11, 2021 (FR) 2102371

(51) Int. Cl. E05B 81/90; E05B 81/04; E05B 79/20; E05B 77/22

(52) U.S. Cl. CPC E05B 81/90; E05B 81/04; E05B 79/20; E05B 77/22

(57) ABSTRACT

A control includes a door lock configured for being actuated mechanically and/or electrically, the control being configured for being mounted on a structure element of the door of the vehicle so as to be integrated in a trim panel of the structure element. It includes a facade panel of an interior face of the door delimiting a decorative external visible face and an opposite masked internal face, the control includes an electric control member of an electrical actuator of the lock, extending on the internal face of the panel and a control interface associated with the electric control member, including a control region extending on the external face.

The present invention relates to an interior opening control for an automobile door and a vehicle door equipped with such a control. It applies particularly to an interior opening control for a door of a vehicle comprising a door lock configured for being actuated mechanically or electrically.

Traditionally, the interior opening control of the prior art comprises a housing and a pivoting maneuvering member, normally referred to as a gripping pallet, that can be moved between an idle position flush with the housing and a working position projecting out of the housing. To mechanically actuate the lock of the door, the passenger seizes the gripping pallet from its idle position as far as its working position, which causes traction on a cable connected to the lock. The passenger can then move the side door between a closed position and an open position.

Generally, the interior opening control is configured for being mounted on a structure element of the side door, such as the inside lining of the door, and integrated in an interior trim assembly by means of which the structure element of the side door can be at least partially covered from the interior of the vehicle.

A current trend, in the design of automobiles, is to make the door opening controls as discreet as possible by attempting to conceal them.

One development in vehicles is thus tending towards replacing the mechanical control members by electrical control members. With regard to the external opening controls, providing an electrically controlled actuator for the electronic actuation of the door lock is thus known.

However, although these electrical control members are highly reliable, it is necessary, in particular for the interior opening control of the door, to keep a backup mechanical-actuation maneuvering member for the door in the event of absence of electrical supply.

This maneuvering member must remain visible and easily accessible in order to be located quickly, in particular in an emergency situation abruptly depriving the automobile of an electrical supply and requiring rapid extraction of the passengers out of the vehicle. It will be understood clearly that such a necessary safety requirement takes precedence over considerations of a purely aesthetic nature.

Thus, in general terms, the interior opening controls, even if they are more or less embedded in the door panel, remain highly visible. Generally, they are in the form of a housing inside which the maneuvering member of the gripping pallet type is mounted, the housing having a generally concave shape inside which a user can pass his hand in order to grip the pallet and to actuate it.

In some models, the interior opening control is integrated in an armrest of the door trim by means of which an arm of a passenger of the vehicle can be supported. The armrest may also non-limitatively comprise a door-pocket arrangement and buttons controlling the actuation of a mechanism for raising a window of the door.

These arrangements of the interior opening control are not very aesthetic, in particular because of the lines delimiting the various members from each other constituting the opening control that impair the overall harmonious perception of the whole by an observer.

The aim of the invention is in particular to propose an interior opening control that makes it possible to remedy the aforementioned drawbacks of the prior art and that meet the requirements of safety while being particularly aesthetic and discreet.

For this purpose, the object of the invention is in particular an interior opening control of a door of an automobile comprising a door lock configured for being actuated mechanically and electrically, said control being configured for being mounted on a structure element of the door of the vehicle so as to be integrated in a trim panel of the structure element, characterized in that, said opening control comprising a facade panel of an interior face of the door delimiting a decorative external visible face and an opposite masked internal face, the control comprises an electrical control member of an electrical actuator of the lock, extending on the internal face of the panel, and a control interface associated with the electrical control member, comprising a control region extending on the external face, and in that the control comprises a mechanical maneuvering member for the mechanical actuation of the lock that comprises a gripping pallet conformed to cooperate by embedding in a cutout formed in said panel by complementarity of contour and of surface, the pallet being configured for adopting a retracted idle position flush with the panel and a projecting deployed operating position of mechanical actuation of the lock.

By means of the invention, the interior opening control offers increased ergonomic ease by virtue of the electrical control member and the decorative face of the panel. The mechanical maneuvering member is discreetly integrated on the panel by being in the idle position flush with the panel. The user then perceives an overall single surface on the facade of the interior opening control with a control interface of the electrical control member accessible in the associated control region on the external face of the panel. As the panel and the pallet are adjacent to each other, the user has no difficulty in intuitively accessing the maneuvering member in the event of electrical failure. Furthermore, integrating the maneuvering member in the panel inside the cutout produces a delimitation line of the contour of the gripping pallet that is easily locatable by the user if needed.

The invention may furthermore comprise one or more of the following features.

In a preferred embodiment of the invention, the electrical control member comprises a gestural and/or touch detector configured for transmitting at least one command instruction to the actuator related to a result of a gestural and/or touch detection in said control region.

In a preferred embodiment of the invention, the region is a three-dimensional gestural control space extending opposite the external face of the panel or a two-dimensional touch control surface extending on the external face of the panel.

In a preferred embodiment of the invention, the panel comprises at least one pattern formed on its external face that extends in line with said control region.

In a preferred embodiment of the invention, at least one pattern appears as a luminous pattern when the panel is illuminated on the internal face of the panel.

In a preferred embodiment of the invention, the panel comprises a body formed by a layer opaque to light that is notched or thinned locally to form said pattern.

In a preferred embodiment of the invention, the control comprises a mechanism for pivoting articulation of the maneuvering member on the panel comprising a rotation spindle secured to the panel and a bearing guiding the rotation spindle secured to the maneuvering member, said articulation mechanism having no spring element for returning the maneuvering member into its idle position. This makes it possible to obtain an extremely rudimentary operation of the mechanical actuation of the lock.

In a preferred embodiment of the invention, the control comprises a means for passing a tight spot of the maneuvering member configured for causing a resistance to its movement from the idle position to the operating position that can be overcome by exerting an additional manual force.

In a preferred embodiment of the invention, the means for passing a tight spot comprises a catch and a hollow or projecting relief, such as a blocking stop, each mounted respectively on either one of the panel or the maneuvering member.

In a preferred embodiment of the invention, the maneuvering member is configured for causing the traction on a cable connected to the lock so that pivoting the maneuvering member into its operating position causes a traction on the cable that causes the release of the lock.

In a preferred embodiment of the invention, the cutout in the panel is delimited by an external contour edge of the panel or delimits a window with an internal peripheral edge of the panel delimiting an opening for housing the maneuvering member so as to position the pallet flush with an external face of the panel in its idle position.

In a preferred embodiment of the invention, the peripheral contour of the facade panel delimits, with the pallet, a contour of the external visible face roughly regularly curvilinear and/or rectilinear.

In a preferred embodiment of the invention, the maneuvering member comprises an external facade finishing or cladding identical to an external finishing or cladding of the facade panel.

Yet another object of the invention is a door of an automobile comprising means for attaching a trim panel on its interior face and a support for attaching an interior opening control of the door, the trim panel including an opening which, when this trim panel is attached to the door, follows the periphery of said interior opening control of the door, characterized in that the opening control is an opening control according to the invention.

Other features and advantages of the invention will emerge in the light of the following description, made with reference to the accompanying drawings, wherein:

FIG. 1 is a perspective view of an interior face of a door shell of an automobile comprising an interior opening control according to the invention;

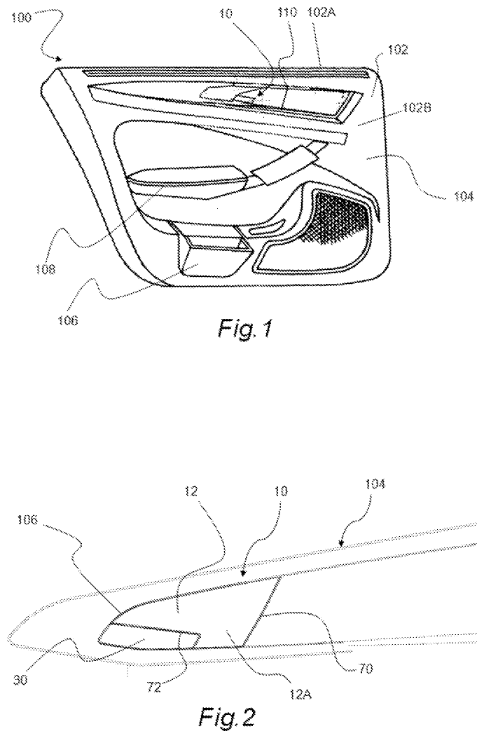

FIG. 2 is a schematic front view of the interior opening control of FIG. 1 integrated in a trim panel of the interior face of the shell;

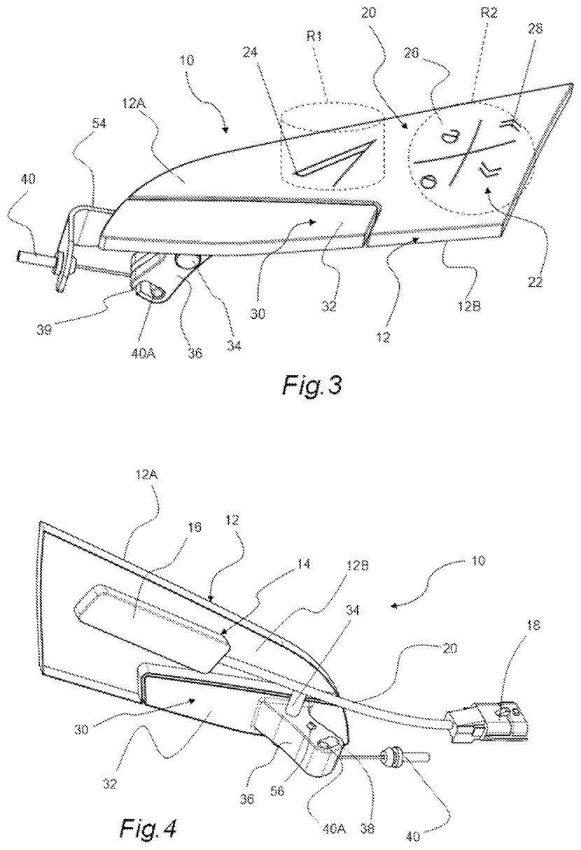

FIG. 3 shows a perspective plan view of the opening control according to the invention;

FIG. 4 shows a perspective view from below of the opening control according to the invention illustrating the electrical actuation of the lock;

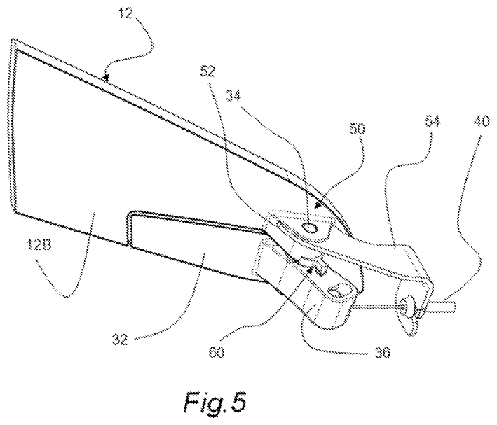

FIG. 5 shows a perspective view from below of the opening control according to the invention illustrating the mechanical actuation of the lock;

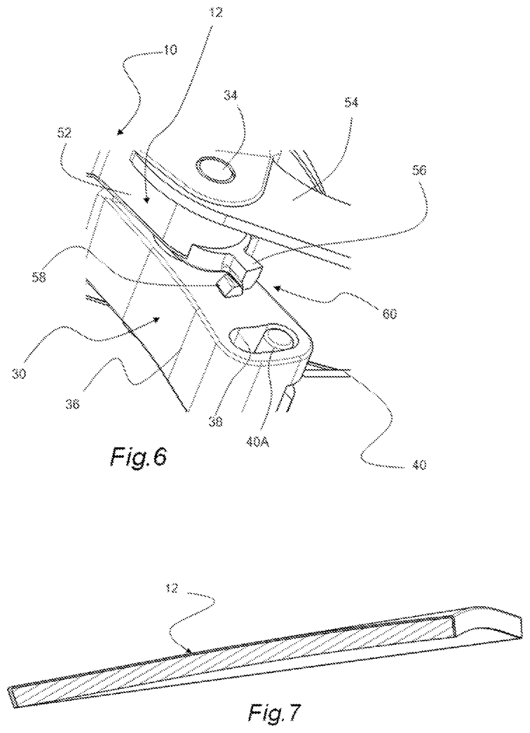

FIG. 6 shows a detail view to an enlarged scale of the opening control illustrated on FIG. 5;

FIG. 7 shows a side view of a section of a facade panel of the opening control shown on FIGS. 3 to 5;

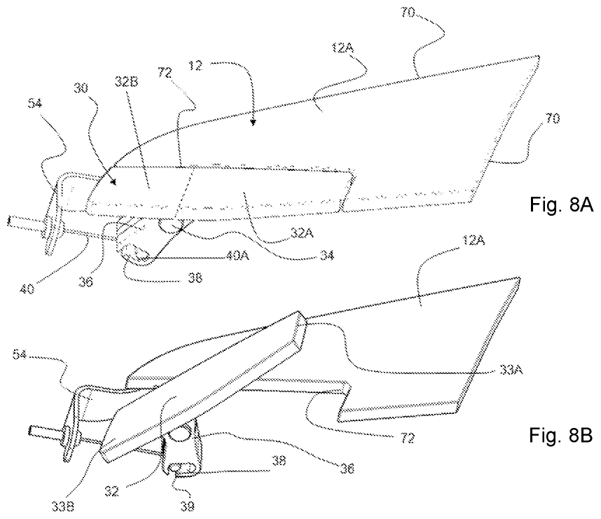

FIGS. 8A-8B show the opening control according to the invention in first 8A and second 8B operating configurations according to the same view in plan perspective;

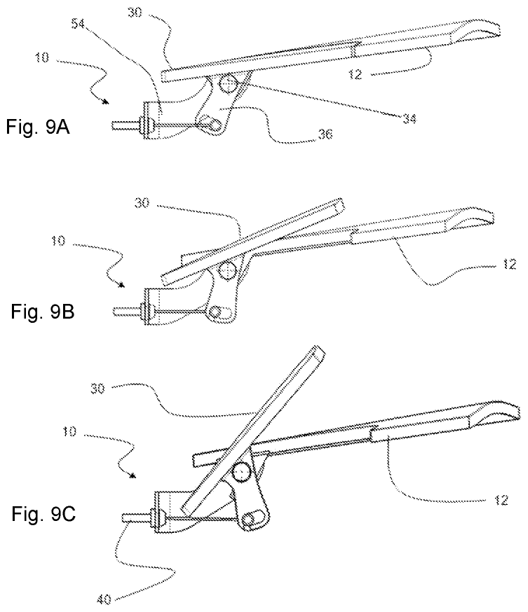

FIGS. 9A-9C show the opening control according to the invention in first to third operating configurations 9A, 9B, 9C according to the same view in side perspective;

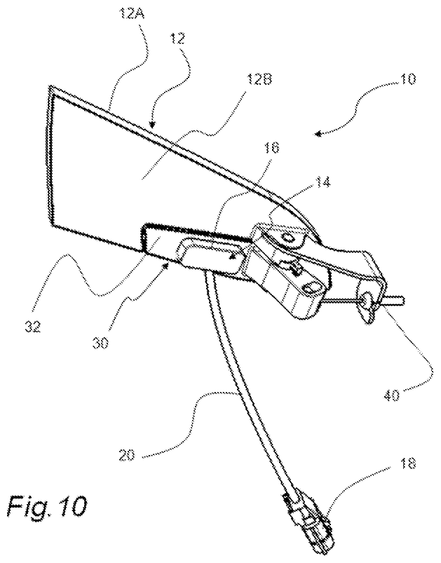

FIG. 10 shows a perspective view from below of the opening control according to a variant of the invention.

FIG. 1 shows an interior face of an automobile door shell comprising an interior opening control according to the invention. In the remainder of the description, the automobile bears the general reference 100 and the interior opening control bears the general reference 10.

In the embodiment presented in the description, it is a question of an opening hatch or door of the leaf type, hinged in its front part on the body of the vehicle. It will be understood however that the invention extends to other types of door, for example hinged in their rear part or in their top part, on the roof of the vehicle.

FIG. 1 shows a door 102 of the automobile 100 comprising an external face 102A (not visible) and an interior face 102B.

The door shell 102 in figure I conventionally comprises an exterior bodywork part and an interior bodywork part (neither visible), the latter commonly being referred to as the interior lining of the door and constituting a rigid structure. On its interior face 102B with respect to the vehicle, the door lining is covered with a trim panel 104, which is attached to an interior face of the lining of the door using means well known to a person skilled in the art.

The interior opening control 10 is configured for being mounted on a structure element of the door of the vehicle, here the door inside lining, so as to be integrated visually in the trim panel 104 of the door inside lining.

This trim panel 104 makes it possible to partially conceal the door inside lining so that the interior of the door is mainly not visible to an observer situated inside the cabin of the automobile 100. In the example illustrated on FIG. 1, the trim panel 104 comprises one or more door trim elements including various functional zones. intended to receive various members or items of equipment of the door, such as a storage tray 106, an armrest 108, etc. Some of these items of equipment, such as the armrest 108, are connected to the door inside panel in order to ensure that they are firmly attached to the rigid structure of the door 102.

As can be seen on FIG. 2, the trim panel 104 generally comprises an opening 110 that, when this trim panel 104 is attached to the door 102, follows the periphery of the part of the interior opening control 10 of the door 102 and thus masks the inside lining of the door 102, in proximity to the opening control 10.

In particular, in the invention, the opening control 10 comprises an interior facade panel 12 of the door 102, delimiting a decorative external visible face 12A and an opposite masked internal face 12B, extending for example facing the inside lining of the door 102.

In the example described, the panel 12 is formed by a piece, for example made from plastics material, the width and length of which are of the same order of magnitude, this order of magnitude being much greater than that of the height (FIG. 7). In the example illustrated, the panel has a roughly planar elongate general form but naturally the panel may in a variant be indifferently round, oval, rectangular or polygonal in shape and the panel may optionally have curved, concave or convex front and rear faces.

Moreover, the interior opening control 10 of the door 102 of an automobile 100 comprises a door lock (not shown), typically mounted on the door of the vehicle and configured for being actuated mechanically and electrically.

Generally, a door 102 of an automobile, for example a vehicle door, is opened by means of a lock comprising a bolt secured to the door able to cooperate with a keeper secured to the bodywork.

In practice, the term opening of the lock is applied to the action of releasing the bolt, which allows the disengagement of the door; conversely, the term closure of the lock is given to the fact of maintaining the bolt in the lock, which prevents the disengagement of the door.

Such a lock thus makes it possible to maintain the door of the automobile in a closed position. The lock also makes it possible to disengage the door by action on the interior (or exterior) opening control connected to the lock and able to be actuated by a user. When the door is opened from outside the vehicle, the bolt is disengaged from the keeper by actuating the exterior opening control.

The lock can be actuated electrically by means of an electromechanical actuator (not shown on the figures). In this case, the actuator comprises for an example an electric motor, electrically supplied by the main electrical circuit of the vehicle; this electric motor is sized to allow the opening of the lock and of the door under normal operating conditions.

For this purpose, the interior opening control 10 according to the invention comprises a member 14 for electrical control of the electromechanical actuator associated with the lock. The electrical control member 14 is visible for example on FIG. 4. It is in this example illustrated in the form of a housing 16 connected to an electrical connector socket 18 by a sheathed electrical cable 20. The electrical member 14 comprises for example a microcontroller housed inside the housing 16 and carried for example by a printed circuit card (neither shown).

In the example described, the electrical control member 14 extends on the interior face 12B (FIG. 3). The control member 14 is associated with a control interface 20, for the user, which preferably extends on the external face 12A of the panel 12 enabling the user to be able to issue control instructions to the electrical control member 14, for example through a thickness of the panel 12.

This is because, in order to increase ergonomic ease, the control interface 20 makes it possible to detect an action or a pressure of a pressing of a user, for example in the present case the driver and, according to the position and the movement associated with the action or the pressure of the pressing, to trigger a command, which is in this example detected and interpreted by the electrical control member 14.

The control interface 20 thus preferably comprises a control region that may be a touch surface R2 or a three-dimensional gestural control space R1 extending opposite the external face 12A of the panel 12.

In the preferred embodiment of the invention, the electrical control member 14 comprises a gestural and/or touch detector (not shown) configured for detecting at least one control instruction related to a use of the gestural and/or touch detection in a control region R1 or R2. The detector defines the control region R1 and R2 of the associated control interface 20.

The detector comprises for example a sensor using a technology of pressure-sensitive resistors (also known by the term FSR sensor, standing for “Force Sensing Resistor”), using for example pressure-sensitive resistive inks, an optical technology or a capacitive technology. Such technologies are well known to a person skilled in the art and will not be detailed further hereinafter.

Furthermore, preferably, the control member 14 also comprises a unit for interpreting the action or a pressing detected to generate a control instruction associated with said action or pressing pressure detected by the detector. For example, the interpretation unit forms a software part programmed in the microcontroller.

In practice, the region R2 is for example formed by a touch surface extending over the external face 12A of the panel 12 opposite the detector, which in its case is situated on the internal face 12B, and the region R1 is for example formed by a three-dimensional gestural control volume space.

In the preferred embodiment of the invention illustrated in FIG. 3, the panel 12 comprises on its external face 12A at least one pattern 22 for locating the control region R1 or R2, comprising for example a pictogram. For example, this pattern 22 is configured for appearing as a luminous pattern when the panel 12 is illuminated on the internal face 12B of the panel 12. In this example, the pattern 22 is a pattern 24 illustrating a door opening control, or a pattern 26 illustrating a command for locking or unlocking a lock of the door 102 (for example comprising a “closed or open padlock” pictogram) or a pattern 22 illustrating a control of a mechanism for lifting a window of the door 102.

In this case, the opening control 10 comprises for example a backlighting light source (not shown), disposed on the internal face 12B, and the panel 12 preferably comprises the body formed by a layer opaque to the light emitted by the light source. In order to form the pattern or patterns 22, the opaque layer may be notched or thinned locally to form the pattern or patterns. Preferably, in practice and as can be seen on FIG. 3, the control region R1 or R2 extends substantially in line with said luminous pattern 22.

In order to allow an operation of the interior opening control 10 under degraded operating conditions, for example occurring in the event of failure of the electrical supply to the opening control 10, according to the invention the control 10 also comprises a maneuvering member 30 for mechanically actuating the lock.

The maneuvering member 30 is mounted so as to be able to rotate about a rotation spindle 34, secured to the panel 12.

This maneuvering member 30 comprises a grippable part 32, normally referred to as a “gripping pallet” having a general elongate shape. This pallet 32 is configured for adopting a retracted idle position flush with the panel 12 and a projecting deployed operating position of mechanical actuation of the lock.

In the example described, the rotation spindle 34 is a spindle positioned on the maneuvering member 30 in order to delimit, on the pallet 32, in a longitudinal direction, a front part 32A and a rear part 32B located on either side of the rotation axis 34. The pallet 32 moreover comprises a proximal end 33A for gripping the pallet 32 and opposite distal end 33B.

In the example illustrated, the rotation spindle 34 of the maneuvering member 30 is disposed at approximately one third of the dimension of the pallet 32 in the longitudinal direction as from the distal end 33B. The rotation spindle 34 may in a variant be substantially median.

As can be seen on the figures, the pallet 14 is conformed so as to cooperate by recessing in a cutout 72 formed in said panel 12 by complementarity of contour and of surface. Consequently, the pallet 32 is aesthetically integrated in the facade panel 12. The peripheral contour 70 of the facade panel delimits for example a recess 72 inside which the pallet 32 extends to delimit together a peripheral contour of the decorative face 12A of the interior opening control 10 roughly regular curvilinear and/or rectilinear.

As illustrated on the figures, the cutout 72 of the panel 12 is delimited by an external contour edge of the panel 12. In a variant that is not illustrated, the panel 12 may delimit a window with an interior peripheral edge of the panel 12 delimiting an opening for receiving the maneuvering member 30. Preferably, the pallet 32 comprises an external facade finish or cladding identical to an external finish or cladding of the facade panel 12. However, the external facade cladding of the pallet 32 can be chosen so as to be distinct from the facade panel 12 in order to facilitate location thereof in the event of emergency situations, requiring rapid extraction from the vehicle.

In operation, the rear part 32B preferably foims a pivoting lever of the pallet 32 and is configured so as to be folded down by pivoting about the spindle 34 towards the inside of the opening 110 of the trim panel 104 in order to leave clear the proximal free end 33A of the front part 32A enabling the pallet 32 to be gripped.

The maneuvering member 30 comprises an elongate arm 36 extending transversely from an internal face of the panel 32, in the direction of the door in a configuration of the interior opening control mounted on the inside door lining. This arm 36 is formed in a single piece with the external main arm foiming the pallet 32 of the maneuvering member 30.

The panel 12 preferably also comprises a support structure 50 for the rotation spindle 34 about which the maneuvering member 30 is pivotally mounted.

As can be seen on FIG. 5, the support structure 50 comprises for example at least one pivot base 52 formed by a protuberance formed projecting on the internal face 12B of the panel 12 and from which the rotation spindle 34 extends integrally.

Furthermore, the maneuvering member 30 comprises a bearing for the rotational guidance of the spindle 34, for example secured to the elongate arm 36.

In practice, the pivot base 52 of the spindle 34 is disposed on the internal face 12B while being adjacent to the cutout 72 so that the maneuvering member 30 can pivot about the rotation spindle 34 by coupling of its guide bearing with the spindle 34.

It will be noted that the rotational articulation mechanism of the maneuvering member 30 on the panel 12 is particularly simple. This mechanism comprises a rotation spindle secured to the panel 12 and a bearing (not visible) for pivotal guiding of the rotation spindle 34 secured to the maneuvering member 30. This articulation mechanism in this example has no spring for return of the maneuvering member 30 to its idle position. Naturally, in a variant that is not illustrated, the articulation mechanism may comprise a spring for return of the maneuvering member.

This mechanical maneuvering member 30 is able to directly control the mechanical actuator of the lock when the pallet 32 pivots.

For this purpose, the member 30 comprises a part for coupling with an element mechanically connected to the lock configured for driving said mechanical actuator. FIG. 4 illustrates a cable 40 by means of which the maneuvering member 30 is connected, downstream of the kinematic chain of the interior opening control 10, to the other members (not shown) of the latter so that the cable 40 can transmit an unlocking command coming from the maneuvering member 30.

In the example described, the maneuvering member 30 is configured for causing the traction of a cable 40 connected to the lock so that the pivoting of the maneuvering member 30 into its operating position causes a traction on the cable 40 that causes the release of the lock.

The arm 36 has for example at its free end a housing 38 for receiving an end 40A of a cable 40 for mechanical traction of the lock that forms said coupling part.

In the example illustrated on FIG. 4, it can be seen that the cable 40 comprises a sheath provided at its proximal end with a head 40A forming an element for holding the cable inside the housing 38. The housing 38 is provided for example with a slot 39 delimiting a guide groove through which the sheath of the cable 40 can be inserted and emerging on an axial extension orifice through which the head 40A of the cable 40 can removably engage axially.

In the example illustrated, the support structure 50 also optionally comprises a tongue 54 folded at a right angle and attached at one end to the pivot base 52 and having a free end for guiding the traction cable 40.

Furthermore, preferably, the control 10 comprises a means 60 for passing a tight spot of the maneuvering member 30 configured for causing a resistance to its movement from the idle position to the operating position that can be overcome by exerting an additional manual force. The user then feels a notch to be passed for opening the door during the mechanical actuation of the lock.

This notch makes it possible in particular to avoid an unwanted actuation of the maneuvering member in the event of shock, for example lateral, that might develop instantaneous accelerations of intensities such that the inertia forces generated may reach or even exceed the traction force normally necessary for opening the door.

Preferably, the means 60 for passing a tight spot comprises a catch or lug cooperating with a hollow or projecting relief formed respectively on either the panel 12 or the maneuvering member 30.

In the example described, the means 60 for passing a tight spot comprises a catch 58 and a blocking stop 56 each mounted respectively on either the panel 12 or the maneuvering member 30. As can be seen in detail on FIG. 6, the catch 58 fonns an extension at the free end of the protuberance forming the pivot base 52. The blocking stop 56 is carried by a face of the elongate arm 36 extending transversely with respect to the rotation spindle 34.

Naturally, these detailed forms of the elements of the means for passing a tight spot are in no way limitative. It will be possible in particular to make provision more generally for the force for passing a tight spot to be greater (or lesser) in a first direction going from the position flush with the operating position than in an opposite second direction. Thus, for example, the stop may comprise asymmetry of relief configured for facilitating passage in the second direction and not in the first.

Furthermore, in a variant that is not illustrated, the relief cooperating with the catch or the lug may be hollow so that the force for passing the tight spot is implemented mainly for disengaging the lug out of the hollow when the member is actuated for opening the door. When returning to the flush idle position of the maneuvering member, the force to be supplied is advantageously reduced since the lug is easily repositioned in the hollow.

Moreover, in the example illustrated on FIG. 4, the housing 16 of the electric control member 14 is carried by the panel 12 on the internal face 12B. In a variant, as illustrated on FIG. 10, the housing 16 of the electric control member 14 is carried by the maneuvering member 30, still on the internal face 12B of the panel 12. Thus, in this variant, the maneuvering member 30 and the housing 16 form together a piece that can be attached to the panel 12.

The main operating aspects of an interior opening control according to the invention will now be described with reference to the figures.

Initially, the user is inside the automobile, in the cabin, for example on the driver's seat.

Under normal operating conditions, the user can actuate the opening of the lock making it possible to release the door 102 by an action or a pressing pressure with the hand in the predefined control region Ri or R2 situated in proximity to the external face 12A of the panel 12. This action or pressing pressure is then detected and interpreted by the electric control member 14, which then translates it in the form of a control instruction that the member 14 sends, for example, to the onboard computer of the automobile 100.

Under nocturnal conditions, the user can easily locate the control region Ri or R2 and the appropriate action or pressing pressure to be implemented to make it possible to send the required control instruction by virtue of the luminous appearance of the patterns 22. This location is thus facilitated by the backlighting of the facade panel 12 on the interior face 12B enabling the patterns 22 to appear luminous in darkness.

As illustrated in FIG. 3, the user in this example has access to various functionalities such as for example the locking-unlocking of the door lock (pattern 26) or the opening of the door (pattern 24) and finally the actuation of a mechanism of raising a window associated with the door (pattern 28).

Under degraded operating conditions such as may occur in the event of an accident or electrical failure, the user can mechanically actuate the opening of the door 102.

The user then causes the tilting of the maneuvering member 30 by applying a pressing-in force on the rear part 32B of the gripping pallet 32 from its idle position (FIG. 9A). This has the effect of releasing the grippable end 33A of the front part 33 of the pallet 32 out of the cutout 32 of the panel 12, which enables the user to grip the pallet 32. During the pivoting travel of the maneuvering member 30, the user feels a tight spot 60. The presence of this tight spot 60 dissuades from frequent or unwanted use of this maneuvering member 30. This tight spot 60 thus causes a temporary stoppage of the pivoting travel of the maneuvering member 30 towards its deployed position (FIG. 9B).

The user then exerts additional force making it possible to overcome this tight spot 60 and continues the pivoting travel of the pallet 32. This has the effect of exerting a traction on the cable 40 and unlocking the lock as well as releasing the door 102 allowing opening thereof (FIG. 9C).

The invention therefore makes it possible to provide an interior opening control that is particularly aesthetic, guaranteeing the safety of the passengers in the vehicle while offering increased ergonomic ease. One of the advantages of the invention is also to make it possible to provide an interior opening control with a very simplified mechanical design by reducing in particular the number of mechanical elements. This thus has an important advantage not only in terms of reduction of costs and in terms of reduction of the weight of the interior opening control. Moreover, it allows an integration of the mechanical maneuvering member that is very discreet.

The invention is not limited to the embodiments described above. Other embodiments within the capability of a person skilled in the art can also be envisaged without departing from the scope of the invention defined by the following claims. Amendments to the Claims:
The following listing of claims will replace all prior versions, and listings, of claims in the application:

1. An interior opening control of a door of an automobile comprising a door lock configured for being actuated mechanically and electrically, the control being configured for being mounted on a structure element of the door of the vehicle so as to be integrated in a trim panel of the structure element, wherein, the opening control comprising a facade panel of an interior face of the door delimiting a decorative external visible face and an opposite masked internal face, the control comprises an electrical control member of an electrical actuator of the lock, extending on the internal face of the panel, and a control interface associated with the electrical control member, comprising a control region extending on the external face, and in that the control comprises a mechanical maneuvering member for the mechanical actuation of the lock that comprises a gripping pallet conformed to cooperate by embedding in a cutout formed in the panel by complementarity of contour and of surface, the pallet being configured for adopting a retracted idle position flush with the panel and a projecting deployed operating position of mechanical actuation of the lock.

2. The opening control according to claim 1, the electrical control member comprises a gestural and/or touch detector configured for transmitting at least one command instruction to the actuator related to a result of a gestural and/or touch detection in the control region.

3. The opening control according to claim 1, wherein the region is a three-dimensional gestural control space extending opposite the external face of the panel or a two-dimensional touch control surface extending on the external face of the panel.

4. The opening control according to clam 1, wherein the panel comprises at least one pattern formed on its external face that extends in line with the control region.

5. The opening control according to claim 1, wherein at least one pattern appears as a luminous pattern when the panel is illuminated on the internal face of the panel.

6. The opening control according to claim 1, wherein the panel comprises a body formed by a layer opaque to light that is notched or thinned locally to form the pattern.

7. The opening control according to claim 1, comprising a mechanism for pivoting articulation of the maneuvering member on the panel comprising a rotation spindle secured to the panel and a bearing guiding the rotation spindle secured to the maneuvering member, the articulation mechanism having no spring element for returning the maneuvering member into its idle position.

8. The opening control according to claim 1, comprising a means for passing a tight spot of the maneuvering member configured for causing a resistance to its movement from the idle position to the operating position that can be overcome by exerting an additional manual force.

9. The opening control according to claim 1, wherein the means for passing a tight spot comprises a catch and a hollow or projecting relief, such as a blocking stop, each mounted respectively on either one of the panel or the maneuvering member.

10. The opening control according to claim 1, wherein the maneuvering member is configured for causing the traction on a cable connected to the lock so that pivoting the maneuvering member into its operating position causes a traction on the cable that causes the release of the lock.

11. The opening control according to claim 1, wherein the cutout in the panel is delimited by an external contour edge of the panel or delimits a window with an internal peripheral edge of panel delimiting an opening for housing the maneuvering member so as to position the pallet flush with an external face of the panel in its idle position.

12. The opening control according to claim 1, wherein the peripheral contour of the facade panel delimits, with the pallet, a contour that is roughly regularly curvilinear and/or rectilinear.

13. The opening control according to claim 1, wherein the maneuvering member comprises an external facade finishing or cladding identical to an external finishing or cladding of the facade panel.

14. The door of an automobile comprising means for attaching a trim panel on its interior face and a support for attaching an interior opening control of the door, the trim panel including an opening which, when this trim panel is attached to the door, follows the periphery of the interior opening control of the, door, wherein the opening control control is an opening control according to claim 1.
